(19) United States
(12) Patent Application Publication
(10) Pub. No.: US 2011/0254786 A1
(43) Pub. Date: Oct. 20, 2011

(54) MOVABLE TOUCH MODULE AND ELECTRONIC DEVICE USING THE SAME

(76) Inventors: Li-Juan WEN, Shanghai (CN); Shih-Wei Hung, Taipei (TW)

(21) Appl. No.: 13/086,658

(22) Filed: Apr. 14, 2011

(30) Foreign Application Priority Data
Apr. 15, 2010 (CN) 201010148223.4

(51) Int. Cl. G06F 3/041

(52) U.S. Cl. 345/173

(57) ABSTRACT

A movable touch module and an electronic device using the same are provided. The movable touch module is disposed at a main body and includes a suspending element, a touch unit, a four-direction sensing element, and at least two rotation sensing elements. The suspending element is disposed at the main body and is movable relative to the main body on a plane. The suspending element has a plurality of elastic portions against the main body. The touch unit is fastened to the suspending element. The four-direction sensing element and the rotation sensing elements are fastened to the main body. When the suspending element moves along a direction on the plane, the suspending element triggers the four-direction sensing element along the direction. When the suspending element rotates on the plane, the suspending element correspondingly triggers one of the rotation sensing elements.

### CROSS REFERENCE TO RELATED APPLICATIONS

This Non-provisional application claims priority under 35 U.S.C. §119(a) on Patent Application No(s). 201010148223.4 filed in People's Republic of China on Apr. 15, 2010, the entire contents of which are hereby incorporated by reference.

### BACKGROUND OF THE INVENTION

1. Field of Invention

This invention relates to an input device and, more particularly, to a movable touch module and an electronic device using the same.

2. Description of the Related Art

With development of science, electronic devices, such as a notebook computer, a mobile communication device, and a media player, have been necessary equipment in people's daily life. In addition, with gradual development of a market, besides functionality of the electronic devices, designs and shapes of the devices are main factors affecting purchase of consumers.

A notebook computer is taken for example. At present, the notebook computer usually has a touchpad to replace a mouse. However, the present touchpad is usually fastened to a main body of the notebook computer, which fails to provide a novel design to show individual styles and also fails to provide intuitive operation such as moving or rotating for users. In addition, when a screen of a notebook computer is not large enough, the users usually need to move a web page upward, downward, leftward, or rightward for complete browse. However, the present touchpad fails to conveniently achieve the above operation.

### BRIEF SUMMARY OF THE INVENTION

This invention provides a movable touch module and an electronic device using the same to improve the prior art.

This invention provides a movable touch module disposed at a main body. The movable touch module includes a suspending element, a touch unit, a four-direction sensing element, and at least two rotation sensing elements. The suspending element is disposed at the main body and is movable relative to the main body on a plane. The suspending element has a plurality of elastic portions against the main body. The touch unit is fastened to the suspending element. The four-direction sensing element and the rotation sensing elements are fastened to the main body. When the suspending element moves along a direction on the plane, the suspending element triggers the four-direction sensing element along the direction. When the suspending element rotates on the plane, the suspending element correspondingly triggers one of the rotation sensing elements.

This invention also provides an electronic device including a main body and a movable touch module. The movable touch module is disposed at the main body and includes a suspending element, a touch unit, a four-direction sensing element, and at least two rotation sensing elements. The suspending element is disposed at the main body and is movable relative to the main body on a plane. The suspending element has a plurality of elastic portions against the main body. The touch unit is fastened to the suspending element. The four-direction sensing element and the rotation sensing elements are fastened to the main body. When the suspending element moves along a direction on the plane, the suspending element triggers the four-direction sensing element along the direction. When the suspending element rotates on the plane, the suspending element correspondingly triggers one of the rotation sensing elements.

In the invention, the suspending element of the movable touch module is movable relative to the main body on a plane. Further, the touch unit is fastened to the suspending element. Thereby, a user can operate the touch unit to allow the suspending element to move along the plane or rotate on the plane to trigger the four-direction sensing element along different directions or to trigger different rotation sensing elements, to achieve different functions. Thus, the movable touch module and the electronic device using the same in the invention provide a novel design and a convenient and efficient operating mode.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an electronic device according to one preferred embodiment of this invention;

FIG. 2 is a partial exploded diagram showing an electronic device according to one preferred embodiment of this invention;

FIG. 3A is a partial sectional diagram showing the electronic device along a line A-A′ in FIG. 1;

FIG. 3B is a partial sectional diagram showing the electronic device along a line B-B′ in FIG. 1; and

FIG. 4A to FIG. 4D are schematic diagrams showing operation of a movable touch module according to one preferred embodiment of this invention.

### DETAILED DESCRIPTION OF THE INVENTION

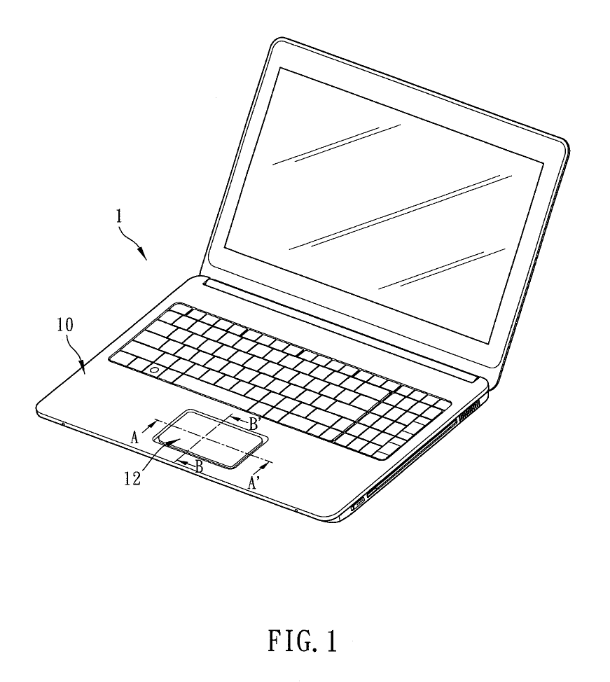

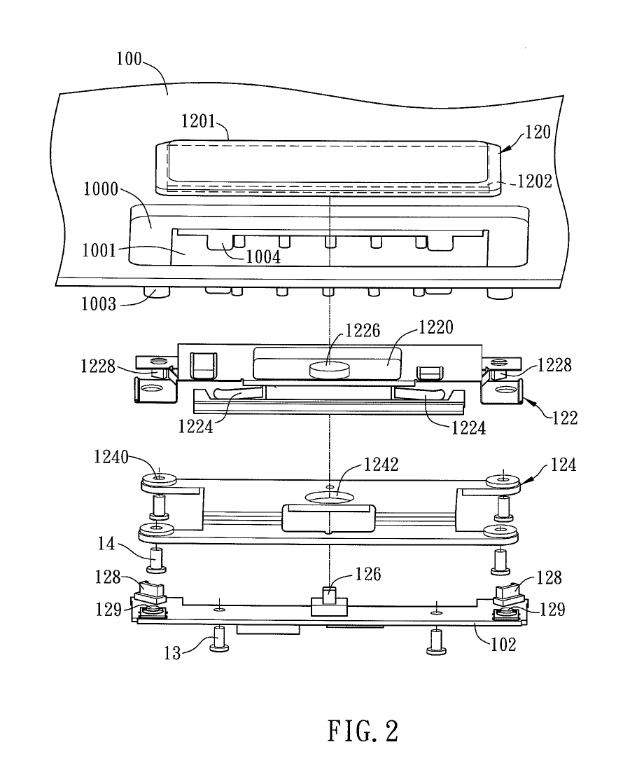

FIG. 1 is a schematic diagram showing an electronic device according to one preferred embodiment of this invention. FIG. 2 is a partial exploded diagram showing an electronic device according to one preferred embodiment of this invention. In FIG. 1 and FIG. 2, in the embodiment, an electronic device 1 includes a main body 10 and a movable touch module 12.

In the embodiment, the electronic device 1 is a notebook computer. However, the invention is not limited thereto. In other embodiments, the electronic device 1 may also be other electronic devices such as a mobile communication device or a media player.

In the embodiment, the movable touch module 12 is disposed at the main body 10. The main body 10 includes a casing 100 and a circuit board 102. The movable touch module 12 includes a suspending element 122, a touch unit 120, a fastening element 124, a four-direction sensing element 126, at least two rotation sensing elements 128, and two pressing switches 129. However, the invention is not limited thereto.

In the embodiment, the suspending element 122 is disposed at the main body 10 and is movable relative to the main body 10 on a plane. In the embodiment, the plane is a plane where the fastening element 124 is disposed. However, the invention is not limited thereto. In a practical application, the plane where the suspending element 122 is movable relative to the main body 10 can be set according to needs.

In the embodiment, the touch unit 120 is fastened to the suspending element 122. The suspending element 122 is located between the touch unit 120 and the fastening element 124. The fastening element 124 is fastened to the casing 100 of the main body 10 and is located between the suspending element 122 and the circuit board 102. The circuit board 102 is fastened to the fastening element 124. The four-direction sensing element 126, the rotation sensing elements 128, and the pressing switches 129 are fastened to the circuit board 102 of the main body 10.

In the embodiment, the casing 100 of the main body 10 is a casing of a notebook computer. The touch unit 120 is disposed at the casing 100. In detail, in FIG. 2, the casing 100 has a recessed containing area 1000. The containing area 1000 has an opening 1001. The touch unit 120 is disposed in the containing area 1000, and a back surface of the touch unit 120 can be exposed to the opening 1001 to be fastened to the suspending element 122. In addition, in the embodiment, the opening 1001 is rectangular. However, the invention is not limited thereto.

In the embodiment, a size of the touch unit 120 is smaller than that of the containing area 1000. In FIG. 2, there is a certain distance between the touch unit 120 and side walls of the containing area 1000. Further, the bottom surface of the containing area 1000 can be parallel to the plane where the suspending element 122 is movable relative to the main body 10. Thereby, in the embodiment, the touch unit 120 can move upward, downward, leftward, rightward, or rotate in the containing area 1000, i.e., along the bottom surface of the containing area 1000. However, the invention is not limited thereto. In other embodiments, the casing 100 may not have the containing area 1000, and the touch unit 120 may be directly disposed on the casing 100. Otherwise, the bottom surface of the containing area 1000 may not be parallel to the plane where the suspending element 122 is movable relative to the main body 10. At that moment, the upward, downward, leftward, rightward movement or rotation of the touch unit 120 may not be performed along the bottom surface of the containing area 1000.

In the embodiment, an assembling direction of the touch unit 120, the suspending element 122, the fastening element 124, and the circuit board 102 is vertical to the plane where the suspending element 122 is movable relative to the main body 10 (such as, the plane where the fastening element 124 is disposed). In detail, the fastening element 124 and the circuit board 102 are disposed in the casing 100 and are located under the opening 1000. The touch unit 120, the suspending element 122, and the fastening element 124 are located on the circuit board 102. In addition, in the embodiment, the circuit board 102 is fastened to the bottom of the fastening element 124 via screws 13. The four-direction sensing element 126, the rotation sensing elements 128, and the pressing switches 129 may be fastened to the circuit board 102 via surface mount technology (SMT). However, the invention is not limited thereto.

In the embodiment, the bottom surface of the containing area 1000 of the casing 100 is parallel to the plane where the fastening element 124 is disposed. Therefore, when the touch unit 120 moves upward or downward along the bottom surface of the containing area 1000 or rotate on the bottom surface of the containing area 1000, the suspending element 122 can also move upward or downward along the plane where the fastening element 124 is disposed or rotate on the plane where the fastening element 124 is disposed. However, the invention is not limited thereto.

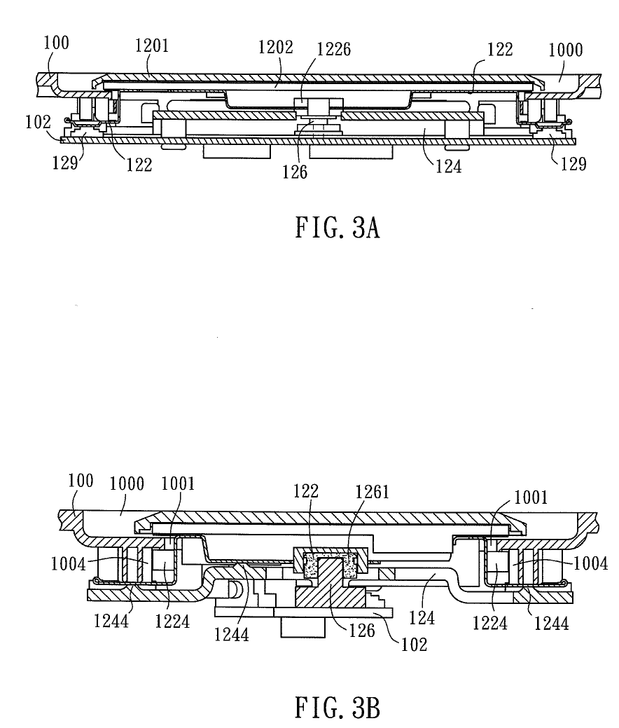

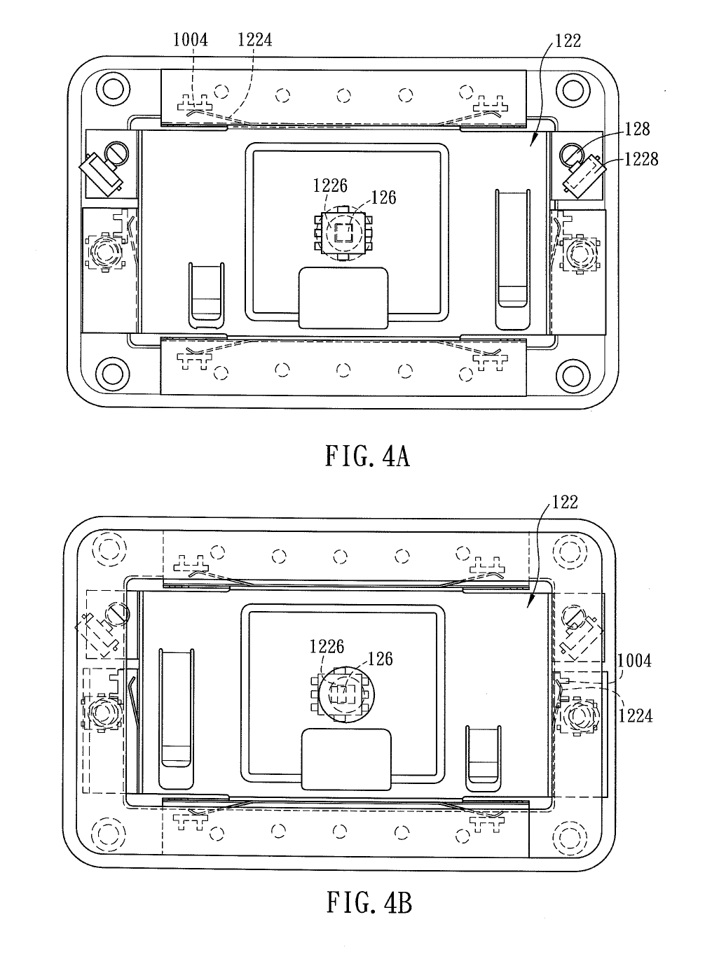

A detailed structure of the movable touch module 12 is described hereinbelow. FIG. 3A is a partial sectional diagram showing the electronic device 1 along a line A-A′ in FIG. 1. FIG. 3B is a partial sectional diagram showing the electronic device 1 along a line B-B′ in FIG. 1. Please refer to FIG. 1, FIG. 2, FIG. 3A, and FIG. 3B.

In the embodiment, the touch unit 120 is rectangular. However, the invention is not limited thereto. In a practical application, the touch unit with different shapes (such as a circle or an ellipse) can be set according to needs.

In the embodiment, in FIG. 2, the touch unit 120 includes a touch appearance element 1201 and a touch pad 1202. The touch appearance element 1201 is fastened to the touch pad 1202. The touch pad 1202 is disposed at the containing area 1000 of the casing 100 and the back surface thereof is protrudent from the opening 1001 to be fastened to the suspending element 122. The touch appearance element 1201 may be a touch film, and the touch pad 1202 may be an electronic sensing pad. In addition, the touch pad 1202 may be connected with a circuit board or a motherboard of the main body 10 via a flexible flat cable (FFC) to achieve functions of a conventional touch pad. For example, the touch pad 1202 may sense movement of a finger of a user on the touch appearance element 1201 to control movement of a cursor on a screen.

In the embodiment, the touch unit 120 is fastened to the suspending element 122. In detail, the back surface of the touch pad 1202 can be attached to the top of the suspending element 122 to achieve fixedness therebetween. However, the invention is not limited thereto. In other embodiments, the touch pad 1202 can have a recessed portion, and the top of the suspending element 122 can have a protrudent portion. The protrudent portion can be fastened to the recessed portion thus to fasten the touch pad 1202 and the suspending element 122.

In the embodiment, the fastening element 124 is fastened to the casing 100 for supporting the suspending element 122 and the touch unit 120. In detail, the fastening element 124 has four holes 1240 at four corners, and the casing 100 correspondingly has four fastening portions 1003 at the back surface. The fastening portions 1003 have screw holes (not shown). Four screws 14 pass through the holes 1240 of the fastening element 124 to be fastened to the fastening portions 1003 at the bottom surface of the casing 100, thereby fastening the fastening element 124 to the casing 100. In addition, in FIG. 2, the fastening portions 1003 are protrudent from the bottom surface of the casing 100. Thus, after the screws 14 are fastened to the fastening portions 1003, the fastening element 124 is not directly attached to the bottom surface of the casing 100. Thereby, the suspending element 122 is movably located on the fastening element 124. However, the invention is not limited thereto. In other embodiments, the fastening element 124 may not be disposed, and the suspending element 122 and the touch unit 120 may be directly supported by the circuit board 102.

In the embodiment, the suspending element 122 has a main body portion 1220, a plurality of elastic portions 1224, a containing portion 1226, and two rotation triggering portions 1228. The elastic portions 1224 are disposed around the main body portion 1220 and are against the casing 100 of the main body 10. The containing portion 1226 is disposed at the center of the main body portion 1220. The two rotation triggering portions 1228 are protrudent from the back surface of the main body portion 1220 and are disposed at two sides of the containing portion 1226. However, the invention does not limit the number of the rotation triggering portions 1228 and the positions of the containing portion 1226 and the rotation triggering portions 1228.

In the embodiment, in detail, the casing 100 has a plurality of stopping walls 1004 protrudent from the bottom surface and disposed around the opening 1001. The elastic portions 1224 of the suspending element 122 are against the stopping walls 1004 of the casing 100, respectively. In the embodiment, the number of the elastic portions 1224 of the suspending element 122 is six, and the elastic portions 1224 are elastic sheets. However, the invention does not limit the number (such as four) and type (such as springs) of the elastic portions.

In the embodiment, the four-direction sensing element 126 fastened to the circuit board 102 is protrudent from a hole 1242 of the fastening element 124 and is located in the containing portion 1226 of the suspending element 122. In the embodiment, the size of the hole 1242 of the fastening element 124 is greater than that of the containing portion 1226 thus to prevent the containing portion 1226 from interfering in triggering of the four-direction sensing element 126. In addition, the containing portion 1226 is circular. However, the invention is not limited thereto. In other embodiments, the containing portion 1226 may be rectangular. In addition, in the embodiment, in FIG. 3B, the four-direction sensing element 126 has a rubber sleeve 1261 for reducing movement errors thus to provide better operating feeling for users. However, the invention is not limited thereto.

In the embodiment, the two rotation sensing elements 128 fastened to the circuit board 102 are located at one side of the corresponding rotation triggering portion 1228 of the suspending element 122, respectively. However, the invention does not limit the number of the rotation sensing elements 128.

In addition, the invention does not limit the positions of the four-direction sensing element 126 and the rotation sensing elements 128, as long as they are located at a moving or rotating path of the suspending element 122.

In the embodiment, in FIG. 3A, the two pressing switches 129 fastened to the circuit board 102 are protrudent from the fastening element 124 and are located under the suspending element 122, respectively. In FIG. 3B, the fastening element 124 has three protrudent points 1244 at the surface and the protrudent points 1244 are located at a center line of the fastening element 124 along the line B-B′. Thus, via the protrudent points 1244, the suspending element 122 can sway at the center line of the fastening element 124 along the line B-B′. That is, the user can press the touch unit 120 along an assembling direction of the touch unit 120. Since the two pressing switches 129 are located under the suspending element 122, when the touch unit 120 is pressed, the suspending element 122 can trigger the corresponding pressing switch 129. However, the invention does not limit the positions of the pressing switches 129. In addition, the two pressing switches 129 are equivalent to left and right buttons around a touch area of a conventional notebook computer. In other words, the movable touch module 12 in the embodiment has a left and right button function.

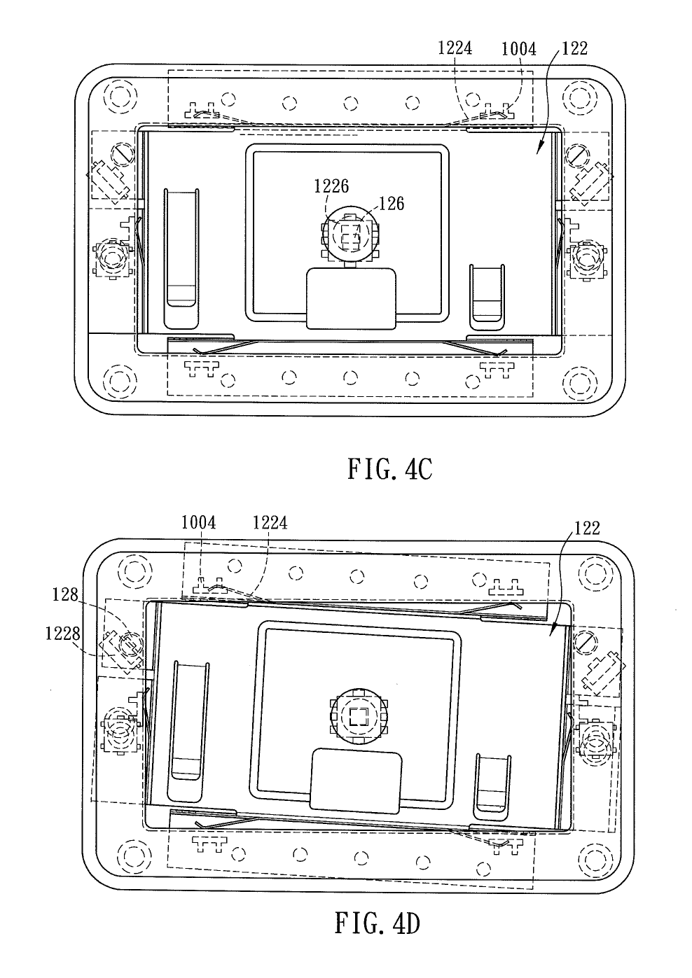

FIG. 4A and FIG. 4D are schematic diagrams showing operation of the movable touch module according to one preferred embodiment of the invention. Please refer to FIG. 2, FIG. 4A, FIG. 4B, FIG. 4C, and FIG. 4D.

In the embodiment, in FIG. 4A, the suspending element 122 is at an initial position (that is, the touch unit 120 does not move). At that moment, the containing portion 1226 of the suspending element 122 does not contact the four-direction sensing element 126, and the rotation triggering portions 1228 does not contact any rotation sensing elements 128. The elastic portions 1224 of the suspending element 122 are against the stopping walls 1004 of the casing 100 to keep balance of the suspending element 122.

In the embodiment, when the user operates the touch unit 120 to move upward, downward, leftward, or rightward along the bottom surface of the containing area 1000 of the casing 100 or to rotate on the bottom surface of the containing area 1000, since the touch unit 120 is fastened to the suspending element 122, the suspending element 122 can move upward, downward, leftward, or rightward relative to the main body 10 on the plate where the fastening element 124 is disposed or rotate on the plane where the fastening element 124 is disposed.

In detail, when the user operates the touch unit 120 to move rightward along the bottom surface of the containing area 1000 of the casing 100, in FIG. 4B, the suspending element 122 can move rightward along the plane where the fastening element 124 is disposed, and the left side wall of the containing portion 1226 of the suspending element 122 can contact and trigger the four-direction sensing element 126 rightward, further to control the electronic device to perform a corresponding operation (such as moving a picture rightward or turning a web page rightward). At that moment, the right elastic portions 1224 of the suspending element 122 may contact the stopping wall 1004 of the casing 100 at a right side of the suspending element 122 to be compressed. Afterwards, when the user releases the touch unit 120, the right elastic portions 1224 of the suspending element 122 can push the suspending element 122 back to the initial position via elastic force. In addition, since the left elastic portions 1224 of the suspending element 122 also has certain elastic force, the suspending element 122 can ensure that it may not deviate the initial position due to push of the right elastic portions 1224.

For example, in a practical application, when a screen of a notebook computer is not large enough, the user can move the touch unit 120 rightward to control a current web page to correspondingly move rightward. When the user releases the touch unit 120, the web page may stop moving, and the corresponding portion of the web page can be shown on the screen. Thus, the user can conveniently browse the web page just by moving the touch unit 120 along different directions.

In addition. in the embodiment, when the user operates the touch unit 120 to move leftward along the bottom surface of the containing area 1000 of the casing 100, the suspending element 122 can move leftward along the plane where the fastening element 124 is disposed, and the right side wall of the containing portion 1226 of the suspending element 122 can contact and trigger the four-direction sensing element 126 leftward, further to control the electronic device to perform a corresponding operation (such as moving a picture leftward or turning a web page leftward). At that moment, the left elastic portions 1224 of the suspending element 122 may contact the stopping walls 1004 of the casing 100 at the left side to be compressed. Afterwards, when the user releases the touch unit 120, the left elastic portions 1224 of the suspending element 122 can push the suspending element 122 back to the initial position via elastic force thereof.

In the embodiment, when the user operates the touch unit 120 to move upward along the bottom surface of the containing area 1000 of the casing 100, in FIG. 4C, the suspending element 122 can move upward along the plane where the fastening element 124 is disposed, and the lower side wall of the containing portion 1226 of the suspending element 122 can contact and trigger the four-direction sensing element 126 upward, further to control the electronic device to perform a corresponding operation (such as moving a picture upward or turning up volume). At that moment, the upper elastic portions 1224 of the suspending element 122 can contact the stopping wall 1004 of the casing 100 at an upper side to be compressed. Afterwards, when the user releases the touch unit 120, the upper elastic portions 1224 of the suspending element 122 can push the suspending element 122 back to the initial position via the elastic force thereof. In addition, since the lower elastic portions 1224 of the suspending element 122 also have certain elastic force, the suspending element 122 can ensure that it may not deviate the initial position due to push of the upper elastic portions 1224.

In addition, in the embodiment, when the user operates the touch unit 120 to move downward along the bottom surface of the containing area 1000 of the casing 100, the suspending element 122 can move downward along the plane where the fastening element 124 is disposed, and the upper side wall of the containing portion 1226 of the suspending element 122 can contact and trigger the four-direction sensing element 126 downward, further to control the electronic device to perform a corresponding operation (such as moving a picture downward or turning down volume). At that moment, the lower elastic portions 1224 of the suspending element 122 can contact the stopping walls 1004 of the casing 100 at the lower side to be compressed. Afterwards, when the user releases the touch unit 120, the lower elastic portions 1224 of the suspending element 122 can push the suspending element 122 back to the initial position via the elastic force thereof.

In the embodiment, when the user operates the touch unit 120 to rotate clockwise on the bottom surface of the containing area 1000 of the casing 100, in FIG. 4D, the suspending element 122 can rotate clockwise on the plane where the fastening element 124 is disposed, and the left rotation triggering portions 1228 of the suspending element 122 can contact and trigger the rotation sensing element 128 at the left side, further to control the electronic device to perform a corresponding operation (such as rotating a picture clockwise or starting a certain program). At that moment, the elastic portions 1224 at the four side walls of the suspending element 122 can contact the surrounding stopping walls 1004 of the casing 100 to be compressed. Afterwards, when the user releases the touch unit 120, the elastic portions 1224 of the suspending element 122 can push the suspending element 122 back to the initial position via the elastic force thereof. In addition, since the elastic portions 1224 are disposed at the four side walls of the suspending element 122, the suspending element 122 can be ensured to be back to the initial position.

In addition, in the embodiment, when the user operates the touch unit 120 to rotate counter-clockwise on the bottom surface of the containing area 1000 of the casing 100, the suspending element 122 can rotate counter-clockwise on the plane where the fastening element 124 is disposed, and the right rotation triggering portion 1228 of the suspending element 122 can contact and trigger the rotation sensing element 128 at the right side, further to control the electronic device to perform a corresponding operation (such as rotating a picture counter-clockwise or stopping a certain program). At that moment, the elastic portions 1224 at four side walls of the suspending element 122 can contact the surrounding stopping walls 1004 of the casing 100 to be compressed. Afterwards, when the user releases the touch unit 120, the elastic portions 1224 can push the suspending element 122 back to the initial position via the elastic force thereof.

In addition, in the embodiment, the four-direction sensing element 126 is a four-direction toggle switch, and the rotation sensing elements 128 are toggle switches. Therefore, when the four-direction sensing element 126 or the rotation sensing elements 128 are triggered, the four-direction sensing element 126 or the rotation sensing elements 128 can be restored by itself or themselves.

In addition, in the embodiment, the movable touch module 12 also has a left and right button function. In FIG. 3A, the user can press the touch unit 120 to trigger the covered pressing switches 129. The touch unit 120 can be restored to the initial position via elasticity of the pressing switches 129.

To sum up, in the embodiment, the suspending element of the movable touch module is movable relative to the main body on a plane. Further, the touch unit is fastened to the suspending element. Thus, the user can operate the touch unit to allow the suspending element to move along the plane or rotate on the plane to trigger the four-direction sensing element along different directions or to trigger different rotation sensing elements, to achieve different functions. In addition, in the embodiment the movable touch module also has a left and right button function. Thus, the movable touch module and the electronic device using the same in the embodiment provide a novel design and a convenient and efficient operating mode.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A movable touch module disposed at a main body, the movable touch module comprising:
a suspending element disposed at the main body and being movable relative to the main body on a plane, the suspending element having a plurality of elastic portions against the main body;
a touch unit fastened to the suspending element;
a four-direction sensing element fastened to the main body; and
at least two rotation sensing elements fastened to the main body,
wherein when the suspending element moves along a direction on the plane, the suspending element triggers the four-direction sensing element along the direction, and when the suspending element rotates on the plane, the suspending element correspondingly triggers one of the rotation sensing elements.

2. The movable touch module according to claim 1, wherein the main body comprises a circuit board and a casing, the casing has a containing area, the touch unit is disposed at the containing area, the circuit board is disposed in the casing, and the four-direction sensing element and the rotation sensing elements are fastened to the circuit board.

3. The movable touch module according to claim 1, wherein the movable touch module further comprises two pressing switches fastened to the main body, and the touch unit covers the pressing switches.

4. The movable touch module according to claim 1, wherein the movable touch module further comprises a fastening element fastened to the main body.

5. The movable touch module according to claim 1, wherein the touch unit comprises a touch appearance element and a touch pad, the touch appearance element is fastened to the touch pad, and the touch pad is fastened to the suspending element.

6. The movable touch module according to claim 1, wherein the suspending element further has a containing portion and at least two rotation triggering portions, the rotation triggering portions are disposed at two sides of the containing portion, and the four-direction sensing element is located in the containing portion.

7. An electronic device comprising:
a main body; and
a movable touch module disposed at the main body, the movable touch module including:
a suspending element disposed at the main body and being movable relative to the main body on a plane, the suspending element having a plurality of elastic portions against the main body;
a touch unit fastened to the suspending element;
a four-direction sensing element fastened to the main body; and
at least two rotation sensing elements fastened to the main body,
wherein when the suspending element moves along a direction on the plane, the suspending element triggers the four-direction sensing element along the direction, and when the suspending element rotates on the plane, the suspending element correspondingly triggers one of the rotation sensing elements.

8. The electronic device according to claim 7, wherein the main body comprise a circuit board and a casing, the casing has a containing area, the touch unit is disposed at the containing area, the circuit board is disposed in the casing, and the four-direction sensing element and the rotation sensing elements are fastened to the circuit board.

9. The electronic device according to claim 7, wherein the movable touch module further comprises two pressing switches fastened to the main body, and the touch unit covers the pressing switches.

10. The electronic device according to claim 7, wherein the movable touch module further comprises a fastening element fastened to the main body.

11. The electronic device according to claim 7, wherein the touch unit comprises a touch appearance element and a touch pad, the touch appearance element is fastened to the touch pad, and the touch pad is fastened to the suspending element.

12. The electronic device according to claim 7, wherein the suspending element further has a containing portion and at least two rotation triggering portions, the rotation triggering portions are disposed at two sides of the containing portion, and the four-direction sensing element is located in the containing portion.

13. The electronic device according to claim 7, wherein the electronic device is a notebook computer.
